(19) United States
(12) Patent Application Publication
(10) Pub. No.: US 2015/0227883 A1
(43) Pub. Date: Aug. 13, 2015

(54) SYSTEMS AND METHODS FOR CREATING AND DELIVERING DIGITAL ASSETS

(71) Applicant: FedEx Corporate Services, Inc., Collierville, TN (US)

(72) Inventor: William S. MURPHY, JR., Germantown, TN (US)

(21) Appl. No.: 14/615,472

(22) Filed: Feb. 6, 2015

Related U.S. Application Data
(60) Provisional application No. 61/937,258, filed on Feb. 7, 2014.
(60) Provisional application No. 61/937,231, filed on Feb. 7, 2014.

(51) Int. Cl. G06Q 10/08

(52) U.S. Cl. CPC G06Q 10/083

(57) ABSTRACT

Systems and methods may create and deliver digital assets associated with a product. In one implementation, a method may include receiving, by a processor, a digital asset, wherein the digital asset includes data associated with a product. The method may also include linking, by the processor, the digital asset to the product. The linking may include associating a unique identifier associated with the digital asset to a unique identifier associated with the product. The method may include preparing, by the processor, the digital asset for delivery. The preparation may include determining a destination device associated with a user. The method may further include transmitting, by the processor, the digital asset to the destination device associated with the user, and the transmission may be triggered by a predetermined set of rules.

### CROSS REFERENCES TO RELATED APPLICATIONS

This disclosure claims priority under 35 U.S.C. §119 to U.S. Provisional Application No. 61/937,258, filed on Feb. 7, 2014, and entitled “Digital Delivery,” and U.S. Provisional Application No. 61/937,231, filed on Feb. 7, 2014, and entitled “Delivery Ad Network.” The aforementioned applications are incorporated herein by reference in their entirety.

### TECHNICAL FIELD

The present disclosure relates generally to systems and methods for creating and delivering digital assets. More particularly, the disclosure relates to systems and methods for creating and delivering digital assets and other digital communications associated with a product.

### BACKGROUND

Advances in ecommerce have contributed to an increase in the volume and complexity of commercial activity. Through ecommerce, businesses have found new channels for receiving, routing and distributing different products or shipments. The increase in ecommerce has also created more complex digital information related to products that are delivered to customers or businesses. This increase in volume and complexity has created a need for businesses to creatively receive, route and distribute digital information related to particular physical products.

In addition, there is an increased need for businesses to find creative ways to keep track of data associated with products in a supply chain, such as when such data is only available to other non-related parties in the product supply chain. Furthermore, disruptions in delivery of shipments due to accidents, weather changes, or other unforeseen circumstances may result in business uncertainty as merchants find it difficult to accurately track the real time status of shipments or to inform downstream customers or businesses of the status of shipments. Therefore, there is an increasing need for delivery of digital assets and communications, including real time information on the supply chain history of a product from the time it leaves the warehouse to the ultimate delivery of the product.

Further, sellers of products or third party producers of related products may find it increasingly difficult to deliver specific targeted digital assets or communications to the recipients of the products. In addition, such senders or third parties may find it difficult to customize the types of digital assets and communications delivered to specific recipients based on other business rules or relationships.

The increasing complexity in the types of products available has also increased the need for improved linking between digital assets and physical products. For example, certain products have a physical as well as a digital component, and the timing of delivery of the physical component might affect the timing of delivery of the digital asset. In another example, when physical products used for 3D printing are delivered, there may be a need to deliver additional digital assets or related communications.

Thus, improvements in techniques for linking physical packages with associated digital assets and communications are desirable. In particular, there is an increasing need for improved techniques that allow customers to view digital assets and communications associated with the physical packages or shipments.

### SUMMARY

Consistent with disclosed embodiments, systems and methods are disclosed for intelligently handling the creation and delivery of digital assets, including intelligently linking digital assets to products, updating rules, logic and triggers controlling the delivery of the digital assets, and transmitting or delivering digital assets associated with products.

Consistent with a disclosed embodiment, a computer-implemented digital delivery method may comprise receiving, by a processor, a digital asset, wherein the digital asset includes data associated with a product. The method may also comprise linking, by the processor, the digital asset to the product. The linking may include associating a unique identifier associated with the digital asset to a unique identifier associated with the product. The method may additionally comprise preparing, by the processor, the digital asset for delivery. The preparation may include determining a destination device associated with a user. The method may further include transmitting, by the processor, the digital asset to the destination device associated with the user, and the transmission may be triggered by a predetermined set of rules.

Consistent with a disclosed embodiment, a digital delivery system may include at least one processor and a memory device storing instructions executable by the at least one processor to perform operations that may comprise receiving a digital asset. The digital asset may include data associated with a product. The system may also comprise a memory device storing instructions executable by the at least one processor to perform operations that may further include linking the digital asset to the product. The linking may include associating a unique identifier associated with the digital asset to a unique identifier associated with the product. The system may additionally include a memory device storing instructions executable by the at least one processor to perform operations that may further comprise preparing the digital asset for delivery. The preparation may include determining a destination device associated with a user. The system may further include a memory device storing instructions executable by the at least one processor to perform operations that may further comprise transmitting the digital asset to the destination device associated with the user, and the transmission may be triggered by a predetermined set of rules.

Consistent with yet another disclosed embodiment, a non-transitory computer readable medium is disclosed storing instructions that, when executed by at least one processor, cause the at least one processor to execute a computer-implemented digital delivery method. The method may include receiving a digital asset that includes data associated with a product. The method may further include linking the digital asset to the product. The linking may include associating a unique identifier associated with the digital asset to a unique identifier associated with the product. The medium may further include preparing the digital asset for delivery. The preparation may include determining a destination device associated with a user. The method may further include transmitting the digital asset to the destination device associated with the user, and the transmission may be triggered by a predetermined set of rules.

Both the foregoing general description and the following detailed description are exemplary and are intended to provide further explanation of the disclosed embodiments.

### BRIEF DESCRIPTION OF THE DRAWINGS

The accompanying drawings, which are incorporated in and constitute a part of this specification, illustrate various implementations and aspects of the disclosed embodiments. In the drawings:

FIG. 1 is a block diagram of an exemplary system for delivering digital assets, consistent with a disclosed embodiment.

FIG. 2 illustrates an exemplary flowchart of an exemplary digital asset delivery process consistent with disclosed embodiments.

FIG. 3 depicts an exemplary digital asset consistent with disclosed embodiments.

FIG. 4 depicts an exemplary recipient device consistent with disclosed embodiments.

FIG. 5 depicts an exemplary digital asset delivery process consistent with disclosed embodiments.

FIG. 6 depicts a different example of a digital asset delivery process consistent with disclosed embodiments.

FIG. 7 depicts a block diagram of an exemplary computer system consistent with disclosed embodiments.

### DETAILED DESCRIPTION

The following detailed description refers to the accompanying drawings. Wherever possible, the same reference numbers are used in the drawings and the following description to refer to the same or similar parts. While certain embodiments are described herein, modifications, adaptations and other implementations are possible, without departing from the spirit and scope of the disclosed embodiments. For example, substitutions, additions or modifications may be made to the components illustrated in the drawing, and the exemplary methods described herein may be modified by substituting, reordering, or adding steps to the disclosed methods. Accordingly, the following detailed description is not limiting. Instead, the proper scope is defined by the appended claims.

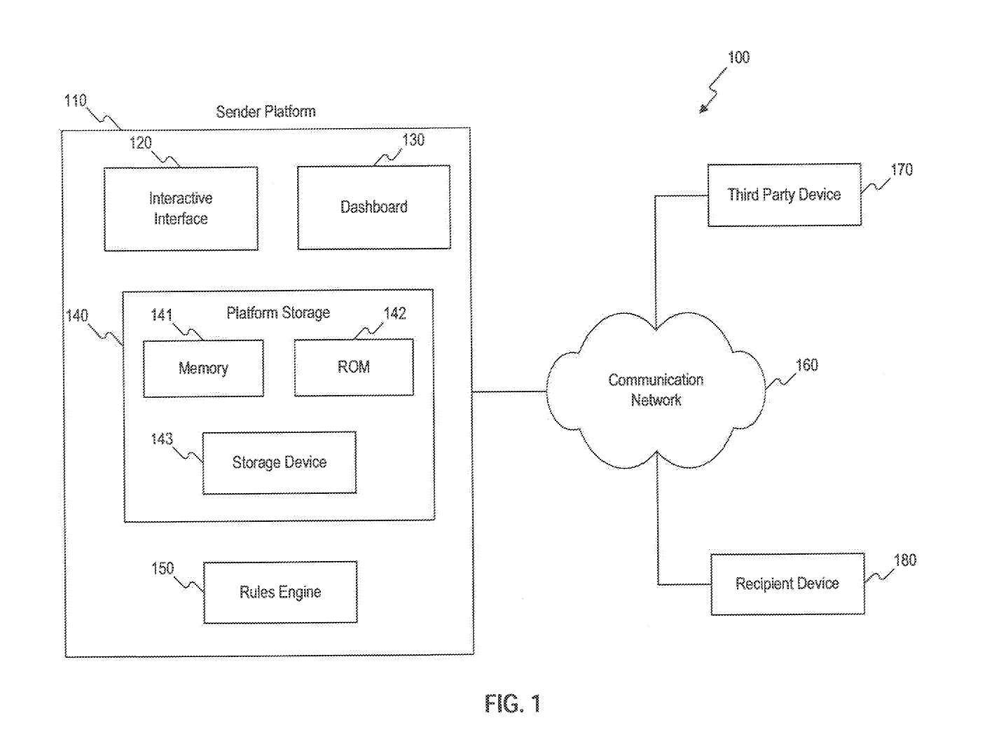

FIG. 1 is a block diagram of an exemplary system for digital asset delivery, consistent with disclosed embodiments. System 100 may include a sender platform 110, a communication network 160, a third party device 170 and a recipient device 180. Sender platform 110 may include an interactive interface 120, a dashboard 130, platform storage 140, and rules engine 150. Platform storage 140 may include memory 141, ROM 142, and storage device 143.

Sender platform 110 may be implemented using a server, desktop computer, workstation, network computer, laptop computer, mainframe, Wi-Fi device, web-enabled cellular telephone, wearable computer or other similar microcomputer-based workstation or network device. Sender platform 110 may comprise any appropriate type of computing or computer operating devices, such as hand-held devices, multiprocessor systems, microprocessor-based or programmable sender electronic devices, minicomputers, mainframe computers, and the like. Sender platform 110 may also be practiced in distributed computing environments where tasks are performed by remote processing devices. Furthermore, sender platform 110 may comprise a mobile terminal, such as a smart phone, a cellular telephone, a cellular telephone utilizing wireless application protocol (WAP), PDA, intelligent pager, portable computer, a hand held computer, a conventional telephone, or a facsimile machine.

Interactive interface 120 may include a single interactive portal allowing for real-time performance of various tasks, viewing of data, or providing access to sub-interfaces on sender platform 110. Interactive interface 120 may include a dynamic Web page using hypertext markup language (“HTML”), and may use other aspects of TCP/IP including the hypertext transfer protocol (“HTTP”); the user datagram protocol (“UDP”); the file transfer protocol (“FTP”); and the extensible markup language (“XML”). Interactive interface 120 may be accessible via the Internet. Further, interactive interface 120 may be interactive, allowing for users to customize the interface, input information, manipulate categories of data, and dynamically view the results of their actions.

Interactive interface 120 may comprise other digital channels of communications including native or installed applications on a desktop computer, laptop computer, mobile computing device, wearable computing device, and other types of computing devices. Interactive interface 120 may be mobile or web based.

Dashboard 130 may include a portal allowing for viewing of summaries of data including user preference data, user historical activity, past orders and other such information stored on sender platform 110. Dashboard 130 may store interactive responses from a recipient or third party and allow future access to these responses. Dashboard 130 may also allow for aggregation and analysis of responses from multiple recipients or third parties. The data may be stored in dashboard 130 for a predetermined period of time.

Dashboard 130 may include a dynamic Web page using hypertext markup language (“HTML”), and may use other aspects of TCP/IP including the hypertext transfer protocol (“HTTP”); the user datagram protocol (“UDP”); the file transfer protocol (“FTP”); and the extensible markup language (“XML”). Dashboard 130 may be accessible via the Internet. Further, dashboard 130 may be interactive, allowing for users to customize the display, input information, manipulate categories of data, and dynamically view the results of their actions.

Platform storage 140 may comprise devices employing hardware- and/or software-based logic to store instructions, media, signaling data, measurement values, and/or other types of information related to delivery of digital assets. For example, platform storage 140 may be implemented in a memory 140, a ROM 142, or a storage device 143.

Platform storage 140 may contain databases including specialized databases as would be recognized by one skilled in the art. Alternatively, the information stored in platform storage 140 may be maintained in structured or unstructured form using a standard file, spreadsheet, or other data assemblage for information storage and retrieval, as is known in the art.

Rules engine 150 may be a computing platform that includes a hardware framework and/or software architecture. Rules engine 150 may include modules integrated with other components of sender platform 110. Rules engine 150 may also include one or more components with access to functionality available through Server Platform 110 and data stored in platform storage 140.

Rules engine 150 may contain one or more rules represented, for example, as logic (for example, application logic) and triggers (for example, database triggers). The logic and triggers may comprise different sets of rules regarding when the delivery or transmission of the digital asset should be initiated.

For example, the logic and triggers may comprise a set of rules that determine, for example, who receives particular digital content, when the digital content should be provided, where and how the digital content is accessible by recipients or third parties, how long the digital content should be offered, and any other conditions which help control distribution of digital content.

In another aspect, the logic and triggers may comprise a set of rules associated with marketplace mechanics. For example, the logic and triggers may comprise rules that trigger delivery of digital assets based on market or demand based characteristics, delivery characteristics, location, recipient demographics, shipping history, product details such as product type, and digital asset placement visibility. For example, the rules may trigger delivery of digital assets based on variation in pricing characteristics such as flat pricing, time based pricing, or variable pricing based on market changes.

Rules engine 150 may implement the logic and triggers as computer programs or modules of computer program instructions, encoded on a computer storage media.

In one example, rules engine 150 may be configured to trigger an action by one or more modules in sender platform 110, such as initiating the transmission or delivery of a digital asset. Rules engine 150 may assess one or more conditional relationships based on information stored in platform storage 140. The execution of a rule may trigger the execution of a predetermined set of additional rules.

Communication network 160 may comprise any data network capable of transmitting or transferring information such as local area networks (LANs), wide area networks (WANs) such as the Internet, and/or metropolitan area networks (MANs). Communication network 160 may operate using any appropriate network protocol, such as asynchronous transfer mode (ATM), Internet protocol (IP), Synchronous Digital Hierarchy (SDH), or synchronous optical network (SONET). Communication network 160 may comprise network devices, such as gateways, servers, routers, switches, or firewalls. Communication network 160 may be a wireless network using free-space optical and/or radio frequency transmission paths, or may be a hardwired network using wired conductors and/or optical fibers. Implementations of networks and/or devices operating on networks described herein are not limited to any particular data type, and/or protocol.

LAN or WAN networking environments are commonplace in offices, enterprise-wide computer networks, intranets, and the Internet, and are known by those skilled in the art. When a LAN is used as communication network 160, a network interface may be used for interconnection. When communication network 160 is implemented in a WAN networking environment, such as the Internet, an internal or external modem or other means for establishing communications over the WAN may be used. Further, data sent over communication network 160 may be encrypted to ensure data security by using known encryption/decryption techniques.

Communication network 160 may comprise a wireless communications system or a combination of wireline and wireless may comprise communication network 160. “Wireless” generally refers to radio transmission via the airwaves, such as cellular, microwave, satellite, packet radio and spread spectrum radio. However, it may be appreciated that various other communication techniques can be used to provide wireless transmission, including infrared line-of-sight. Wireless data may include, but is not limited to, voice data, paging, text messaging, e-mail, Internet access, and other specialized data.

In other aspects, communication network 160 may be implemented using a network, such as the Public Switched Telephone Network. Alternatively, communication network 160 may be implemented on a voice-over-broadband network, such as a network using VoIP technology. Additionally, in other embodiments, communication network 160 may be a video over broadband network, such as, for example, a network for providing two-way video communications. In another example, communication network 160 may be a wireless broadband network, such as, for example, a network using WiFi (for example, IEEE 802.11(b) and/or (g)). In yet another example, communication network 160 may be a wireless voice network(s), such as, for example, a cellular or third-generation cellular network. In addition, communication network 160 may be implemented using any one or a combination of the above-described technologies, consistent with the disclosed embodiments.

Third party device 170 may comprise any device capable of sending information to another device. For example, third party device 170 may include various types of computing devices such as a desktop computer, a laptop computer, a client, a server, a pager, a personal digital assistant (PDA), or another computation or communication device. Third party device 170 may also include devices such as a plain old telephone system (POTS) handset, an Integrated Services Digital Network (ISDN) device, a cellular telephone device, a voice over Internet Protocol (VoIP) device, or different types of telephone devices such as a web-enabled cellular device or an Internet Protocol (IP) telephone. Third party device 170 may include a courier device, a box sensor, a phone or a wearable computing device (for example, Google Glass).

In one aspect, third party device 170 may be implemented using any device capable of accessing the Internet, such as a general purpose computer or personal computer equipped with a modem. In one embodiment, third party device 170 may use instant messaging (“IM”) to communicate with either the sender platform 110 or recipient device 180. In addition, third party device 170 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Third party device 170 may establish a connection with either sender platform 110 or recipient device 180 directly or indirectly, for example, by transmitting data to an intermediate device that may subsequently forward the data to either sender platform 110 or recipient device 180 on behalf of third party device 170. During the connection, third party device 170 may exchange, with sender platform 110 or recipient device 180, a variety of media information such speech, video, text, images or numerical data. Third party device 170 may exchange such media directly or indirectly with either sender platform 110 or recipient device 180. Further, third party device 170 may transmit the data over the same or over different communication channels. In other aspects, third party device 170 may send analog and/or digital data and/or media, including non-packet-based and/or packet based information.

Recipient device 180 may comprise any device capable of sending information to another device. For example, recipient device 180 may include various types of computing devices such as a desktop computer, a laptop computer, a client, a server, a pager, a personal digital assistant (PDA), or another computation or communication device. Recipient device 180 may also include devices such as a plain old telephone system (POTS) handset, an Integrated Services Digital Network (ISDN) device, a cellular telephone device, a voice over Internet Protocol (VoIP) device, or different types of telephone devices such as a web-enabled cellular device or an Internet Protocol (IP) telephone. Recipient device 180 may include a courier device, a box sensor, a phone or a wearable computing device (for example, Google Glass).

In one aspect, recipient device 180 may be implemented using any device capable of accessing the Internet, such as a general purpose computer or personal computer equipped with a modem. In one embodiment, recipient device 180 may use instant messaging (“IM”) to communicate with either the sender platform 110 or third party device 170. In addition, recipient device 180 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Recipient device 180 may establish a connection with either the sender platform 110 or third party device 170 directly or indirectly, for example, by transmitting data to an intermediate device that may subsequently forward the data to either the sender platform 110 or third party device 170 on behalf of recipient device 180. During the connection, recipient device 180 may exchange, with either the sender platform 110 or third party device 170, a variety of media information as part of the data, such speech, video, text, images or numerical data. Recipient device 180 may exchange such media directly or indirectly with either the sender platform 110 or third party device 170. Further, recipient device 180 may transmit the data over the same or over different communication channels. In other aspects, recipient device 180 may send analog and/or digital data and/or media, including non-packet-based and/or packet based information.

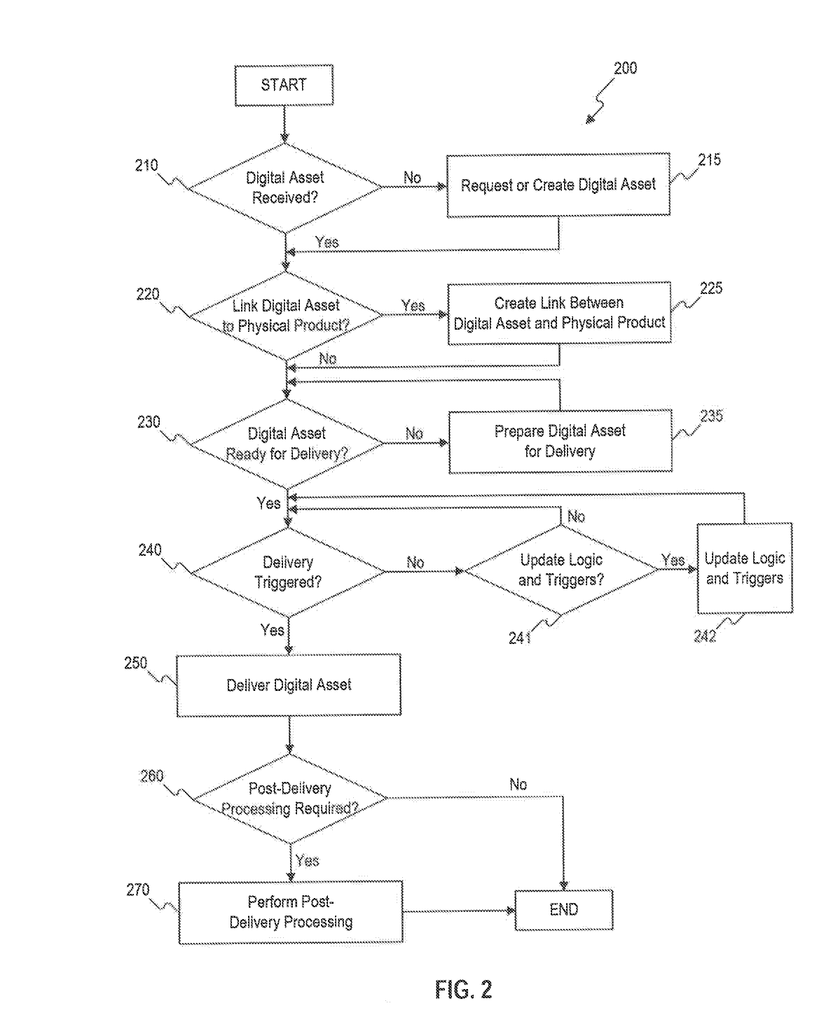

FIG. 2 illustrates an exemplary flowchart of an exemplary digital asset delivery process consistent with a disclosed embodiment. In particular, process 200 relates to a method for creating and delivering digital assets related to a product or shipment.

In Step 210, sender platform 110 may determine whether a digital asset has been received, requested, or created. In one example, sender platform 110 may determine whether a product has been shipped to a recipient and whether an associated digital asset exists. In another example, sender platform 110 may determine whether a digital asset has been received from third party device 170. The sender platform 110 may also determine whether a digital asset is stored in platform storage 140.

A digital asset may include any digital media such as email, text, documents, images, picture files, video files, sound files, data fields, pdf files, web-displayed content, messages on mobile apps, or other types of media items or digital files. The digital asset may be of different formats and may include pre-defined forms, pre-structured data, input-structured data, or unstructured data.

The digital asset may also include application files such as games and apps, application programming interface (API), or other machine-to-machine data. The API may comprise one or more detailed specifications for a combination of one or more functions, data structures, routines, variables, object classes, or other standardized interfaces. The API may be generated based on an operating interface standard such as Portable Operating System Interface (POSIX) or may be specifically defined by the sender or third party. Machine-to-machine communication may be used by any “smart” computing device, including any networked computing device containing autonomous computing software enabling the device to receive data, interpret the data, and make appropriate decisions or perform appropriate actions.

The digital asset may include a user guide, instruction manual, a video of how to install or use a product, or an email cross-selling other products such as similar products or complementary products. The digital assets may also include an interactive form such as product registration, user experience or other types of surveys, feedback forms and other types of interactive media. The digital asset may also include data related to 3D printing including electronic media files including 3D image or print files. In another example, the digital asset may include licenses, warranties, digital invoices, digital packing slips, offers, discounts, marketing communications, product information, and complementary or similar product promotions. The digital asset may include limited use or limited duration items such as coupons with expiry dates, or limited time offer promotions.

The digital asset may be created, received or requested from a sender or a third party. For example, the digital asset may include cross-sell promotions by the sender or third party for other types of products, such as complementary or similar products. The cross-sell promotions may include targeted offers for products and services connected to, for example, a particular product or a package delivery event.

In another example, the digital asset may include data associated with a product or other metadata such as supply chain information, product description, pricing, handling and storage information, geolocation or geofencing information, history log information, inventory management information, and other types of metadata related to the supply chain or product. The information may include details on the supply chain history from shipment dispatch by the originator in the supply chain to product receipt by downstream business or recipient. The digital asset may include, for example, notes added by various parties in the supply chain regarding any unique details on the product or shipment's storage and handling procedures, or any damages or anomalies noted in the shipment.

In some embodiments, the digital asset may have a unique identifier associated with it. The unique identifier may be automatically generated by sender platform 110, or may be generated based on the unique identifier of the product associated with the digital asset. The unique identifier may also be generated based on the content or type of content in the digital asset.

The sender, recipient, or third party could be individual user, a business, or other type of organization involved in any step in the supply chain of either a physical or digital product or the digital asset. For example, the sender recipient or third party may be an organization that conducts any type of ecommerce activity.

In Step 215, sender platform 110 may create, request, or receive the digital asset. For example, sender platform 110 may request a digital asset from a third party device 170. In another example, sender platform 110 may create a digital asset based on the product associated with the digital asset. Sender platform 110 may create a digital asset based on product category, delivery location, delivery time, recipient identification and demographic information, tracking number, product information or other related information.

Sender platform 110 may optimize the link between the digital asset and product based on shipment or product specific information or contextual metadata, such as consignee details, package content details, environmental information, and unstructured data such as comments and pictures provided by sender, recipient or third party.

Sender platform 110 may optimize the link between the digital asset and product based on historical information about the recipient shipping behavior including previous items delivered, frequency of items delivered, previous senders of shipments and similar historical metadata.

In Step 220, sender platform 110 may determine whether to link the digital asset to a product or shipment. This determination could be made, for example, based on sender, recipient, or third party preferences associated with interactive platform 120 and/or dashboard 130. Alternatively, this determination could be made based on the application logic or database triggers stored in rules engine 150.

In step 225, sender platform 110 may create a link between the digital asset and the product. The link may be to a physical product, shipment or package. For example, a sender or third party using sender platform 110 may manually or automatically connect a digital asset to a product by using the tracking number, another unique identifier of the product or shipment, or other information unique to the product or shipment.

The sender platform 110 may create different types of links. For example, the link may be established between a unique digital asset (with a unique identifier) and a unique product (with a unique identifier), or between a unique digital asset to one or more sets of predetermined products, or between one or more sets of digital assets and a unique product, or between one or more types of digital assets and one or more types of products. The link could be established based on unique shipping information combined with other information that allows for targeting of specific types of digital assets to recipients of specific types of products or shipments.

In some embodiments, the link may be based on sender information, product category, delivery location, delivery time, recipient identification and demographic information, tracking number, product information, and/or digital asset information.

The link between the digital asset and the product may be customized. For example, a recipient or third party may customize, using interactive interface 120 or the dashboard 130, the types of digital assets of interest based on the recipient's and/or third party's preferences. The recipient and/or third party may also associate one or more types of digital assets to one or more types of products.

In some embodiments, the third party may transmit digital assets to sender platform 110, using the third party device 170. The digital asses may be associated with a particular product type, product identifier, tracking number, or other identifier associated with a product or shipment. The third party's preferences may be stored in the dashboard 130 for future reference. Further, the third party may access the stored preferences in the dashboard 130 and modify, update, or make any relevant changes or customizations. The third party may have access to all the asset delivery capabilities, communication, triggering, and other mechanism of sender platform 110.

In Step 230, sender platform 110 may determine whether the digital asset is ready for delivery. For example, sender platform 110 may determine one or more destination devices associated with the recipient. In another example, sender platform 110 may determine the destination address associated with recipient device 180. As another example, sender platform 110 may determine the email address associated with the recipient based on information provided either by the recipient using the recipient device 180 or the third party using the third party device 170. The destination address or device may be predetermined based on information stored in interactive interface 120 or dashboard 130.

In Step 235, sender platform 110 may prepare the digital asset for delivery. For example, sender platform 110 may automatically format the digital asset based on predefined rules. As another example, sender platform 110 may format the digital asset based on the type of digital asset to be transmitted. Where the digital asset is a digital media file, the sender platform 110 may format the digital asset according to the means of transmission of the digital asset. The digital asset may be formatted into an email, or could be formatted into an interactive web form with a corresponding link. In some embodiments, the digital asset may be formatted into an appropriate API or machine-to-machine data format.

In Step 240, sender platform 110 may determine whether the delivery or transmission of the digital asset has been triggered. Delivery or transmission of the digital asset may be triggered based on various rules, logic and triggers stored in rules engine 150. The logic and triggers stored in rules engine 150 may contain rules regarding when particular digital assets should be delivered to a recipient. The logic and triggers may also contain a predetermined set of rules regarding timing and means of delivery of the digital asset.

In some embodiments, the transmission or delivery of the digital asset may be triggered based on the timing of the product shelving or product delivery. In some embodiments, the delivery of the digital asset may also be triggered based on the recipient scanning the product label or a bar code related to the product. The delivery of the digital asset may be based on sender or third party preferences, recipient demographics, location, product information, environmental data and other related information.

In some embodiments, the delivery of the digital asset may depend on whether the recipient has opted in or out of receiving certain types of product or digital assets. The delivery of the digital asset may also be customized based on the sender's knowledge of the recipient's preferences for digital asset content or categories of content.

Delivery of the digital asset may be triggered based on geographic location or geofencing data. For example, delivery may be triggered based on geofencing when sender platform 110 determines that the product or recipient device 180 is in a specific location based on, for example, Global Positioning System (GPS) coordinates of the product and/or recipient device 180 combined within a predetermined or dynamically generated radius around the GPS coordinates. This information may trigger the delivery of a digital asset to recipient device 180.

In another aspect, the delivery of the digital asset may be triggered based on proximity between two or more devices, for example, a device connected to the sender platform 110, third Party device 170, and recipient device 180. Such devices may include a courier device, a box sensor, a recipient's phone or an item the recipient is wearing (for example, Google Glass). The devices may recognize each other, for example, using short range communication. Once the devices have recognized each other, communication may occur.

The delivery of the digital asset may be triggered based on the occurrence of an event. For example, the delivery of the digital asset may be triggered by the occurrence of a pre-delivery event, a delivery-point event, a delivery-triggered event, or post-delivery event. A pre-delivery event may include, for example, digital communications between the sender using sender platform 110 and the recipient using recipient device 180 prior to delivery of the product. These communications may comprise interactive data exchange between the sender and the recipient, including, for example, tracking emails, text messages, mobile phone application messages, and wearable computing device messages.

In some embodiments, delivery of the digital asset may be triggered based on a delivery-point event which may include, for example, the recipient of a product initiating the collection of either the digital asset or other digital communication associated with a product delivered. A delivery-point event may include interactions with the product itself, or may include using the tracking number or other unique product identifier to initiate collection of related digital assets.

In some embodiments, the digital asset may be delivered based on a delivery-triggered event which may include, for example, initiation of delivery of digital assets and related digital communications associated with a product when a delivery event by the sender happens. A delivery-triggered event may be driven, for example, by delivery scans by the sender, GPS geofencing, or other similar means. For example, a digital asset may be delivered based on location and delivery information related to a unique product delivery event.

The delivery of the digital asset may be triggered based on a post-delivery event which may include, for example, digital communications between sender and recipient after the product is delivered, or after a pre-determined amount of time has passed since a particular event related to the delivery of the product has occurred. The post-delivery event may include, for example, interactive or two way communications between the sender and the recipient after the product has been delivered.

In another aspect, the delivery of the digital asset may be triggered based on another event, pre-defined or otherwise, that occurs before, during or after delivery of the shipment or product. For example, delivery of the digital asset and associated communications may be triggered by a scan by a package delivery scan, on truck scan, or proximity of the package to a specific device such as a Bluetooth enabled recipient device 180.

In Step 241, sender platform 110 may determine whether to update the logic and/or triggers stored in rules engine 150. For example, sender platform 110 may determine whether the rules, logic or triggers are outdated. Sender platform 110 may also determine whether new sender, recipient and/or third party data necessitates changes in the rules, logic or triggers stored in rules engine 150. In some embodiments, sender platform 110 may determine whether the changes in sender, recipient and/or third party relationships translates to changes in the conditional relationships embodied in the rules, logic or triggers stored in rules engine 150.

In Step 242, sender platform 110 may update the logic and/or triggers stored in rules engine 150. For example, sender platform 110 may automatically update rules, logic and triggers based on the receipt of new data from the sender, recipient and/or third party. The update may also be triggered by changes in the relationships between the sender, recipient and/or third party, or based on supply chain or product history information. For example, sender platform 110 may add, delete, or update the conditional relationships between one or more rules, logic or triggers stored in rules engine 150. Furthermore, the logic and/or triggers stored in rules engine 150 may be updated, changed or varied based on delivery related data, recipient demographic data, product related data, supply chain data, geolocation or geofencing data, time relative to either delivery or other event, or other similar data.

The logic and triggers may also be finely tuned based on sender or third party targeting mechanism created to target for digital assets and offerings to relevant recipients of similar or complementary products.

In Step 250, sender platform 110 may transmit or deliver the digital asset to one or more destination devices associated with the recipient. For example, sender platform 110 may transmit or deliver a digital asset comprising a digital invoice slip or an interactive web form to any recipient device 180 including a desktop computer, a laptop computer, a personal digital assistant (PDA), a cellular telephone device, a voice over Internet Protocol (VoIP) device, Wi-Fi device, a web-enabled cellular device, watches, eyeglass computer, a wearable computer or other similar microcomputer-based workstation or network device.

In another example, the sender platform 110 may deliver a digital asset comprising an API that allows machine-to-machine communications to occur. For example, sender platform 110 may deliver a digital asset to or exchange data with any “smart” networked device associated with third party device 170 or recipient device 180. The sender platform 110 may include APIs that allow third party device 170 or recipient device 180 to automatically access the digital asset or exchange other data with sender platform.

The digital asset may be included in package tracking emails, website tracking updates, text messaging, pop-up messages, or other types of messages that can be delivered to recipient device 180. The digital asset and associated digital content may be delivered along with tracking notifications sent in response to the recipient entering the tracking number or scanning a product identifying code. The digital asset may be delivered, for example, within tracking applications and other related applications interfaces via APIs.

Sender platform 110 may optimize the digital asset delivered based on shipment or product specific information or contextual metadata, such as consignee details, package content details, environmental information, and unstructured data such as comments and pictures provided by sender, recipient or third party.

In another aspect, sender platform 110 may optimize the digital asset delivered based on historical information about the recipient shipping behavior including previous items delivered, frequency of items delivered, previous senders of shipments and similar historical metadata.

In another example, sender platform 110 may optimize the digital asset delivered based on marketplace mechanics. For example, the rules may trigger delivery of digital assets based on time of day, time of year, sender, recipient, sender location, recipient location, or digital asset visibility.

Sender platform 110 may also transmit or delivery other associated information or digital communications. For example, sender platform 110 may deliver metadata related to the link between the product delivered and the digital asset. As another example, sender platform 110 may transmit a digital asset and allow for interactive communication between the sender, recipient and/or third party.

The logic and triggers may consist of rules controlling how and when digital assets need to be delivered. For example, the third party or sender may customize the type of digital assets to be delivered to the customer when a particular product or type of product is contained in a shipment. The third party or sender may also indicate what type of digital asset should be delivered based on recipient demographic data such as age, sex, socioeconomic data, and other related information.

In Step 260, sender platform 110 may determine whether to initiate post-delivery processing. For example, sender Platform 110 may determine, based on the digital asset transmitted or delivered, whether to allow interactive communications between the sender, recipient and/or third party. In another example, if the digital asset contains an interactive web form or product registration link, sender platform 110 may provide relevant access privileges to recipient device 180. Sender platform 110 may determine whether the sender preferences include notifications regarding the delivery of the product and/or the digital asset.

In Step 270, sender platform 110 may perform post-delivery processing. For example, sender platform 110 may send and receive digital communications between a sender, a recipient and/or a third party. Sender platform 110 may notify the sender of the receipt and acceptance of the product and/or digital asset by the recipient. Sender platform 110 may direct the recipient to interactive interface 120 or dashboard 130, where the recipient may provide additional information or feedback to the sender. In another example, sender platform 110 may allow the user to complete an interactive web form or survey, collect the survey information, and store it in platform storage 140.

In some embodiments, sender platform 110 may create a digital social network between one or more senders, recipients and/or third parties. The digital social network may be created, for example, by connecting senders, recipients and/or third parties through interactive interface 120 or dashboard 130 of sender platform 110. The digital social network may be based on the digital assets or products sent or received by the sender, recipient and/or third party. The digital social network may be customized based on the user preferences of the sender, recipient and/or third party.

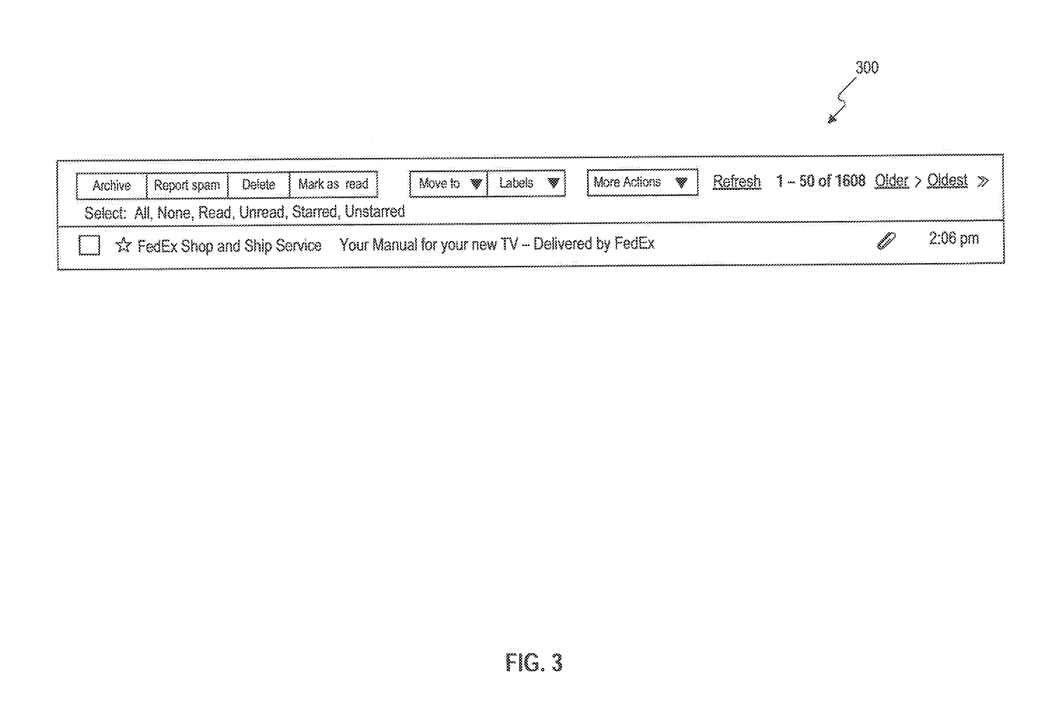

FIG. 3 depicts an exemplary digital asset 300 consistent with disclosed embodiments. In the example illustrated in FIG. 3, digital asset 300 is an email received in recipient's inbox. In this example, the email includes a manual for a TV delivered to the recipient. Digital asset 300 may be transmitted from sender platform 110 to the destination address associated with the recipient or recipient device 180. Although FIG. 3 is an example in which digital asset 300 is an email, digital asset 300 may be any kind targeted digital content such as offers, discounts, marketing communications, product information, warranties and other information matching the product received by the recipient. The digital asset may be delivered in package tracking emails, website tracking updates, text messaging, pop-up messages, or other types of messages. Alternatively, in some embodiments, the digital asset may be sent by the sender or a third party.

In some embodiments, the sender or third party may customize preferences regarding the digital assets to be delivered. Further, the digital asset may include an interactive web form that allows for real-time communication between the recipient and sender or third party.

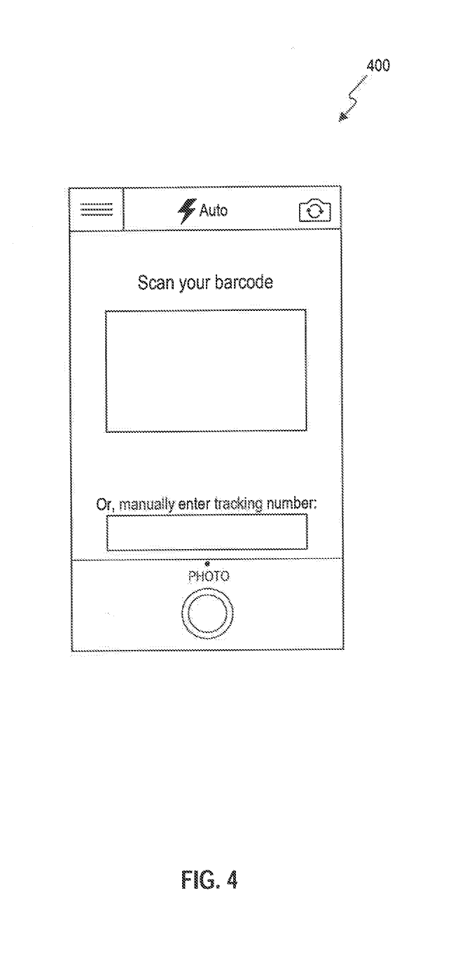

FIG. 4 depicts an exemplary recipient device 400 that may be used in an exemplary digital asset delivery process consistent with disclosed embodiments. As illustrated in FIG. 4, recipient device 400 may have a mobile barcode scanning application. In some embodiments, the recipient device 400 may alternatively allow the recipient to manually enter the tracking number for the product. The scanning of a product or the entry of the tracking number may trigger the delivery of a digital asset linked to the product.

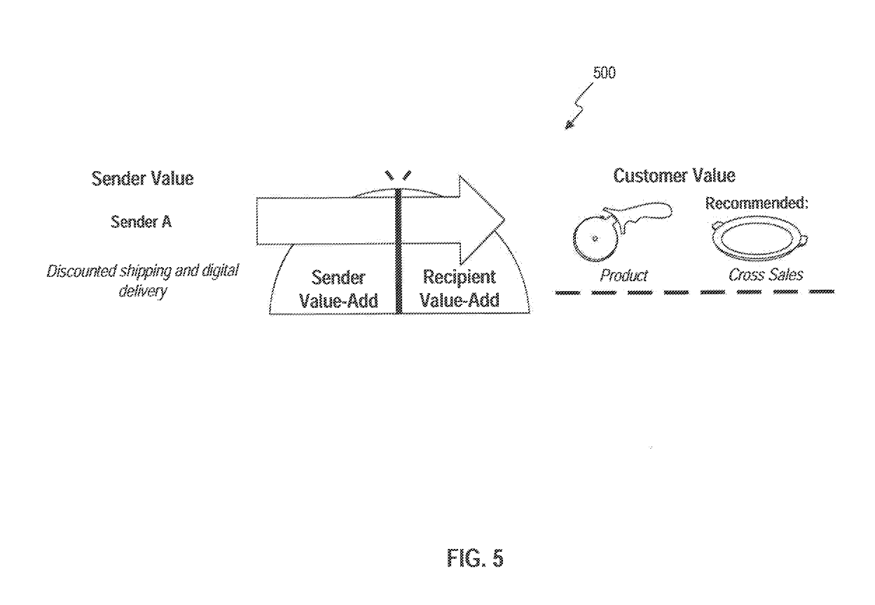

FIG. 5 depicts an exemplary digital asset delivery process 500 consistent with disclosed embodiments. As illustrated in FIG. 5, a sender may transmit a product, such as a pizza cutter, to a recipient. Sender platform 110 may establish a link between the product, in this example a pizza cutter, and a digital asset such as a cross sale offer. The logic and triggers stored in rules engine 150 may trigger delivery of the digital asset, in this case a cross sale offer, to the recipient device 180. The digital asset may be delivered in package tracking emails, website tracking updates, text messaging, pop-up messages, or other types of messages. The digital asset and associated digital content may be delivered along with tracking notifications sent in response to the recipient entering the tracking number or scanning a product identifying code. The digital asset may be delivered, for example, within tracking applications and other related applications interfaces via APIs.

The sender or a third party may cause sender platform 110 to transmit or deliver the digital asset. The sender or third party may customize preferences regarding the digital assets to be delivered. Further, the digital asset may include an interactive web form that allows for real-time communication between the recipient and sender or third party.

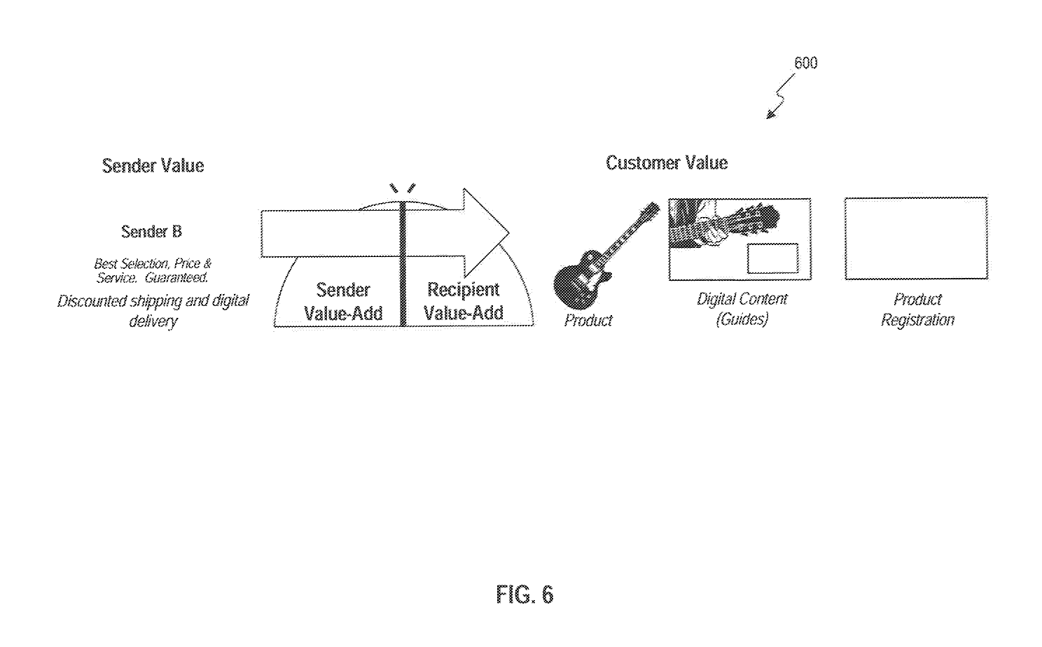

FIG. 6 depicts a digital asset delivery process 600 consistent with disclosed embodiments. As illustrated in FIG. 6, a sender or a third party may transmit a product, such as a guitar, to a recipient.

Sender platform 110 may establish a link between the product, in this example a guitar, and a digital asset such as video guides and product registration forms. The logic and triggers stored in rules engine 150 may trigger delivery of the digital asset, in this case video guides and product registration forms, to the recipient device 180. The digital asset may be delivered in package tracking emails, website tracking updates, text messaging, pop-up messages, or other types of messages. The digital asset and associated digital content may be delivered along with tracking notifications sent in response to the recipient entering the tracking number or scanning a product identifying code. The digital asset may be delivered, for example, within tracking applications and other related applications interfaces via APIs.

After the digital asset is delivered, the recipient may respond to the seller using the product registration form, for example, by clicking on a link included in form or by accessing either interactive interface 120 or dashboard 130.

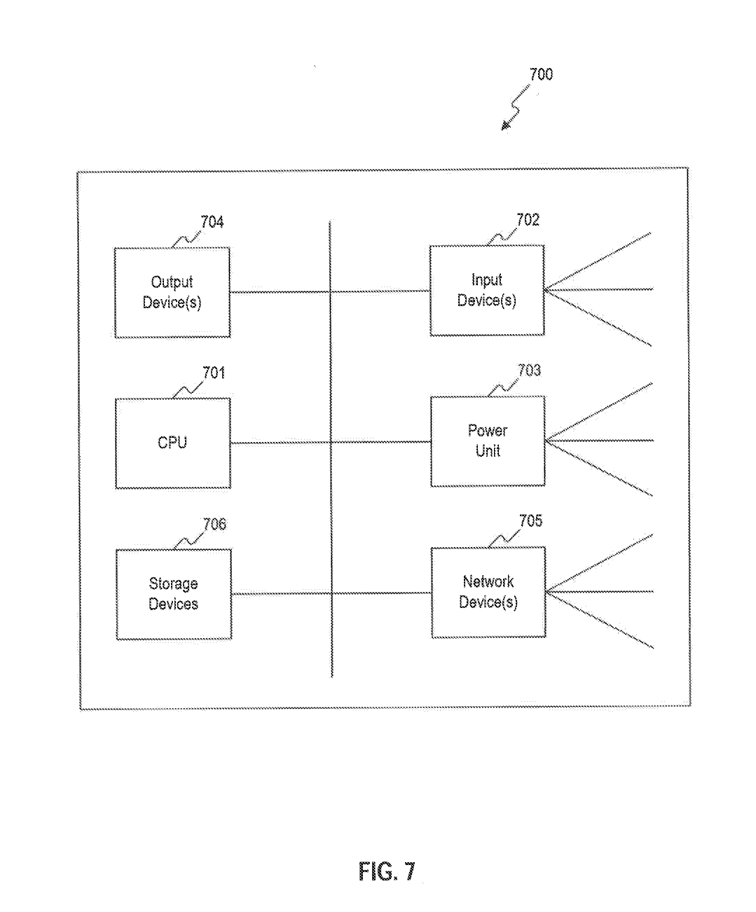

FIG. 7 is an exemplary computing device 700, consistent with disclosed embodiments. In some embodiments, the computing device 700 may correspond to any of the components of system 100, including sender platform 100, third party device 170, or recipient device 180. Although the description may refer to terms commonly used in describing particular computer systems, such as a personal computer, the description and concepts equally apply to other computer systems, such as network computers, workstations, and mainframe computers having architectures dissimilar to FIG. 7.

As shown in FIG. 7, exemplary computer device 700 may include one or more central processing units 701 for managing and processing data and operations consistent with the disclosed embodiments. CPU 701 may be configured to process data, execute software instructions stored in memory, and transmit data between the other components of device 700. For example, CPU 701 may be implemented as a conventional microprocessor, a mobile microprocessor, a desktop microprocessor, a server microprocessor, or any other type of processor.

In some embodiments, computer device 700 may also include one or more input devices 702, which are configured to receive input from a user, other computers, other devices, or other modules. Input devices 702 may include, but are not limited to, keyboards, mice, trackballs, trackpads, scanners, cameras, external storage or information devices, and other devices, which connect via Universal Serial Bus (USB), serial, parallel, infrared, wireless, wired, or other connections.

Computer device 700 may also include one or more power units 703, which may supply operating power to computer device 700 and its components from one or more sources. The power units 703 may include rechargeable batteries, such as lithium-ion or nickel-cadmium batteries, which may be charged using power from a variety of sources such as a photovoltaic device, a wall outlet, a capacitor, or a solar cell. The power units 703 may be wirelessly chargeable.

Computer device 700 may include one or more output devices 704 that may be configured to transmit data to users and/or modules or devices. Such modules or devices may include, but are not limited to, computer monitors, televisions, screens, interface ports, projectors, printers, plotters, and other recording/displaying devices which connect via wired or wireless connections.

Computer device 700 may also include one or more network devices 705. Network device 705 may be configured to allow computer device 700 to connect to and exchange information with one or more networks, such as the Internet, a local area network, a wide area network, a cellular network, a wireless network, or any other type of network. Network device 705 may be implemented as a wired network adapter, a wireless network adapter, an infrared network adapter, a cellular or satellite network adapter, or any other type of network adapter.

Computer device 700 may also include one or more storage devices 706. Storage devices 706 may be comprise optical, magnetic, electronic, or any other type of memory configured to store information. Storage devices 706 may store, for example, data, instructions, programs/applications, operating systems, or a combination of these.

While FIG. 7 illustrates the components of device 700 as connected in a “bus” configuration, other connections and configurations are possible. Additionally, while the devices in FIG. 7 are represented in a singular form, in some embodiments, each of the devices in FIG. 7 may be omitted, duplicated, substituted, or more than one of each of the devices in FIG. 7 may be implemented.

Operation of computer system 700 may be controlled and coordinated by operating system software. The operating system may control allocation of system resources and performs tasks, such as memory management, process scheduling, networking, and services, among other things.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Advantageous results may still be achieved if values or data were different than explicitly disclosed. Other implementations are also within the scope of the present disclosure.

Furthermore, although exemplary embodiments have been described as being associated with data stored in memory and other storage mediums, one skilled in the art will appreciate that these aspects can also be stored on or read from other types of computer-readable media, such as secondary storage devices, hard disks, floppy disks, a CD-ROM, or other forms of RAM or ROM. Further, the steps of the disclosed methods may be modified in any manner, including by reordering steps and/or inserting or deleting steps, without departing from the principles of the disclosed embodiments.

It is intended, therefore, that the specification be considered as exemplary only, with a true scope and spirit being indicated by the following claims and their full scope of equivalents.

What is claimed is:

1. A computer-implemented digital delivery method, comprising:
receiving, by a processor, a digital asset, wherein the digital asset includes data associated with a product;
linking, by the processor, the digital asset to the product, wherein the linking includes associating a unique identifier associated with the digital asset to a unique identifier associated with the product;
preparing, by the processor, the digital asset for delivery, wherein the preparation includes determining a destination device associated with a user; and
transmitting, by the processor, the digital asset to the destination device associated with the user, wherein the transmission is triggered by a predetermined set of rules.

2. The digital delivery method as recited in claim 1, further comprising:
transmitting to the user, by the processor, metadata associated with the digital asset and the product; and
performing by the processor, post-delivery processing, wherein the post-delivery processing includes receiving information from the user based on at least one of the digital asset, the product, the sender, or the third party.

3. The digital delivery method as recited in claim 1, wherein the linking of the digital asset to the product further comprises selecting a pre-determined type of digital asset associated with a pre-determined type of product.

4. The digital delivery method as recited in claim 1, wherein the predetermined set of rules are based on at-least one of: a pre-delivery event, a delivery-point event, a delivery-triggered event, or a post-delivery event.

5. The digital delivery method as recited in claim 1, wherein the predetermined set of rules are based on information related to the supply chain of the product delivered.

6. The digital delivery method as recited in claim 1, wherein the digital asset includes an interactive form.

7. The digital delivery method as recited in claim 1, wherein the digital asset includes an API.

8. A digital delivery system, comprising:
at least one processor;
a memory device storing instructions executable by the at least one processor to perform operations of:
receiving a digital asset, wherein the digital asset includes data associated with a product;
linking the digital asset to the product, wherein the linking includes associating a unique identifier associated with the digital asset to a unique identifier associated with the product;
preparing the digital asset for delivery, wherein the preparation includes determining a destination device associated with a user; and
transmitting the digital asset to the destination device associated with the user, wherein the transmission is triggered by a predetermined set of rules.

9. The digital delivery system of claim 8, wherein the memory device further stores instructions executable by the at least one processor, to perform operations of:
transmitting, to the user, metadata associated with the digital asset and the product; and
performing post-delivery processing, wherein the processing includes collecting information from the user based on at least one of the digital asset, the product, the sender, or the third party.

10. The digital delivery system of claim 8, wherein the linking of the digital asset to the product further comprises selecting a pre-determined type of digital asset associated with a pre-determined type of product.

11. The digital delivery system of claim 8, wherein the predetermined set of rules are based on at-least one of: a pre-delivery event, a delivery-point event, a delivery-triggered event, or a post-delivery event.

12. The digital delivery system of claim 8, wherein the predetermined set of rules are based on information related to the supply chain of the product delivered.

13. The digital delivery system of claim 8, wherein the digital asset includes an interactive form.

14. The digital delivery system of claim 8, wherein the digital asset includes an API.

15. A non-transitory computer readable medium storing instructions that, when executed by at least one processor, cause the at least one processor to execute a computer-implemented digital delivery method, the method comprising:
receiving a digital asset, wherein the digital asset includes data associated with a product;
linking the digital asset to the product, wherein the linking includes associating a unique identifier associated with the digital asset to a unique identifier associated with the product;
preparing the digital asset for delivery, wherein the preparation includes determining a destination device associated with a user; and
transmitting the digital asset to the destination device associated with the user, wherein the transmission is triggered by a predetermined set of rules.

16. The non-transitory computer readable medium of claim 15, the method further comprising:
transmitting to the user metadata associated with the digital asset and the product; and
performing post-delivery processing, wherein the processing includes collecting information from the user based on at least one of the digital asset, the product, the sender, or the third party.

17. The non-transitory computer readable medium of claim 15, wherein the linking of the digital asset to the product further comprises selecting a pre-determined type of digital asset associated with a pre-determined type of product.

18. The non-transitory computer readable medium of claim 15, wherein the predetermined set of rules are based on at-least one of: a pre-delivery event, a delivery-point event, a delivery-triggered event, or a post-delivery event.

19. The non-transitory computer readable medium of claim 15, wherein the predetermined set of rules are based on information related to the supply chain of the product delivered.

20. The non-transitory computer readable medium of claim 15, wherein the digital asset includes an interactive form.

21. The non-transitory computer readable medium of claim 15, wherein the digital asset includes an API.
